(19) United States
(12) Patent Application Publication
(10) Pub. No.: US 2013/0290827 A1
(43) Pub. Date: Oct. 31, 2013

(54) INTEGRATED SEARCH ENGINE HOMEPAGES

(71) Applicants: JOSHUA EDWARD SMITH, Bellevue, WA (US); ABHISHEK JHA, Bellevue, WA (US); SARAH K. BERRIER, Shoreline, WA (US); RAJEEV KUMAR CHAND, Redmond, WA (US); RODRIGO MOREIRA SILVEIRA, Redmond, WA (US)

(72) Inventors: JOSHUA EDWARD SMITH, Bellevue, WA (US); ABHISHEK JHA, Bellevue, WA (US); SARAH K. BERRIER, Shoreline, WA (US); RAJEEV KUMAR CHAND, Redmond, WA (US); RODRIGO MOREIRA SILVEIRA, Redmond, WA (US)

(73) Assignee: MICROSOFT CORPORATION, Redmond, WA (US)

(21) Appl. No.: 13/458,515

(22) Filed: Apr. 27, 2012

(51) Int. Cl. G06F 17/00

(52) U.S. Cl. 715/234

(57) ABSTRACT

Systems, methods, and computer-readable storage media are provided for integrating third party content with search engine homepages. Users indicate preferences for content to be presented in association with all of part of a search engine homepage such that, upon requesting presentation of the search engine homepage, the preferred content is presented. Generally, the preferred content is provided by a third-party content provider. User preferences may be indicated via a user interface control that permits selection of preferred content from a plurality of content options. Upon receiving the user preference, the search engine requests presentation of the preferred content from the third-party provider each time the user requests presentation of the search engine homepage.

### BACKGROUND

Typically, the content presented in association with a search engine homepage is provided by the accompanying search engine. For instance, content presented in association with the BING search engine homepage is generally provided by a BING search server. However, search engines do not always have the richest and most dynamic content centered on particular topics. Additionally, search engine users typically all are presented with the same basic search engine homepage content. If not particularly interested in the content presented at any particular time, users may be turned off from use of the search engine homepage.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer readable storage media for, among other things, integrating third party content with search engine homepages. Utilizing embodiments of the present invention, users are permitted to explicitly and/or implicitly indicate preferences for content to be presented in association with all or part of a search engine homepage such that, upon requesting presentation of the search engine homepage, the user's preferred content is presented. Generally, the preferred content is provided by a third-party content provider, that is, a content provider that is independent of the search engine. User preferences may be indicated explicitly via a user interface control that permits selection of preferred sets of content from a plurality of content options. User preferences also may be indicated implicitly, for instance, based upon previous search behavior or the like. Upon receiving a user preference indication, the search engine requests presentation of the preferred content from the third-party provider each time the user requests presentation of the search engine homepage. In this way, the user is provided with a customized experience and is able to view desired information upon navigating to a search engine homepage.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing an exemplary method for integrating third party content with search engine homepages, in accordance with an embodiment of the present invention;

FIG. 4 is a flow diagram showing another exemplary method for integrating third party content with search engine homepages, in accordance with an embodiment of the present invention;

FIG. 5 is a schematic diagram showing an exemplary screen display of a search engine homepage integrated with third-party provided content, in accordance with an embodiment of the present invention; and

FIG. 6 is a schematic diagram showing an exemplary screen display of a search engine homepage integrated with third-party provided content and having a preference-indication control, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for, among other things, integrating third party content with search engine homepages. In accordance with embodiments hereof, users are permitted to explicitly and/or implicitly indicate preferences for content to be presented in association with all or part of a search engine homepage such that, upon requesting presentation of the search engine homepage, the user's preferred content is presented. Generally, the preferred content is provided by a third-party content provider, that is, a content provider that is independent of the search engine. User preferences may be indicated explicitly via a user interface control that permits selection of preferred sets of content from a plurality of content options. User preferences also may be indicated implicitly, for instance, based upon previous search behavior or the like. Upon receiving a user preference indication, the search engine requests presentation of the preferred content from the third-party provider each time the user requests presentation of the search engine homepage. In this way, the user is provided with a customized experience and is able to view desired information upon navigating to a search engine homepage.

Accordingly, one embodiment of the present invention is directed to one or more computer-readable storage media storing computer-useable instructions that, when used by one or more computing devices, cause the one or more computing devices to perform a method for integrating third party content with search engine homepages. The method includes receiving a request for presentation of a search engine homepage from a user, determining that the user has an explicit or implicit indicated preference for a particular set of content provided by a third party for presentation in association with the search engine homepage, and upon determining that the user has an indicated preference, requesting, from the third party, presentation of at least a portion of the particular set of content in association with the search engine homepage.

In another embodiment, the present invention is directed to a system for integrating third party content with search engine homepages. The system includes a computing device associated with a server having one or more processors and one or more computer-readable storage media and a data store coupled with the server. The server is configured to receive a request for presentation of a search engine homepage from a user; determine that the user has an explicit or implicit indicated preference for a particular set of content provided by a third party for presentation in association with the search engine homepage; and, upon determining that the user has an indicated preference, request from the third party, presentation of at least a portion of the particular set of content in association with the search engine homepage.

In yet another embodiment, the present invention is directed to a method being performed by one or more computing devices including at least one processor, for integrating third party content with search engine homepages. The method includes receiving a request for a search engine homepage from a user, presenting the search engine homepage having a particular set of content associated therewith and presenting a user interface control that permits the user to indicate a preference for one or more other sets of content. Generally, the one or more other sets of content are provided by third party content providers, that is, content providers that are independent of the search engine. The method further includes receiving, via the user interface control, a user selection of a second set of content selected from the one or more other sets of content, and requesting presentation of at least a portion of the second set of content such that it replaces some or all of the particular set of content presented in association with the search engine homepage.

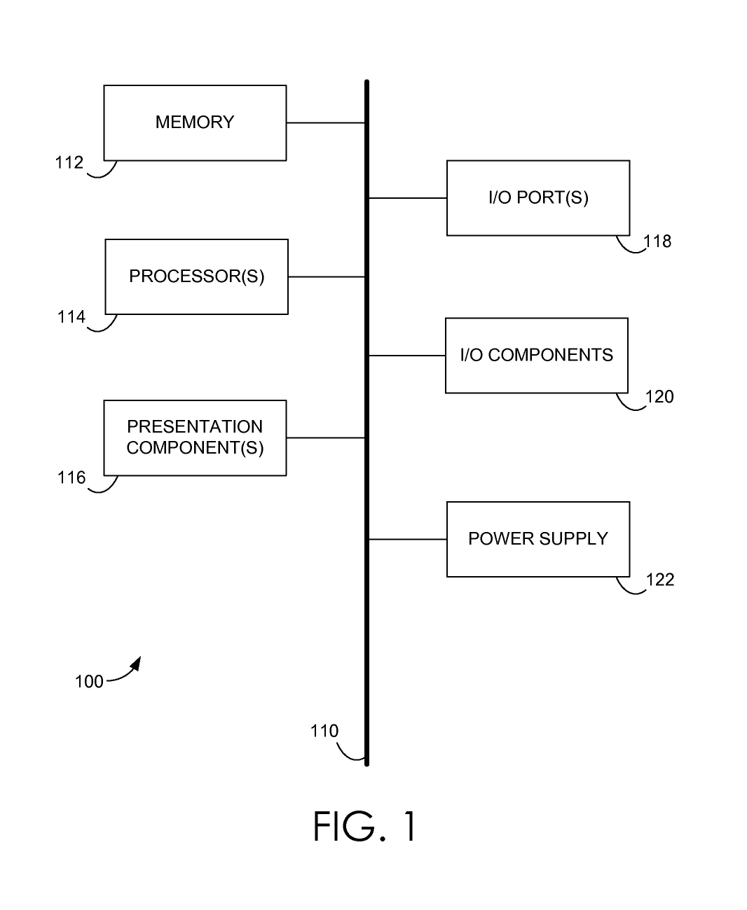

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that can be accessed by the computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above are also included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

As previously mentioned, embodiments of the present invention are generally directed to systems, methods, and computer-readable storage media for, among other things, integrating third party content with search engine homepages. Utilizing embodiments of the present invention, users are permitted to explicitly and/or implicitly indicate preferences for content to be presented in association with all or part of a search engine homepage such that, upon requesting presentation of the search engine homepage, the user's preferred content is presented. Generally, the preferred content is provided by a third-party content provider, that is, a content provider that is independent of the search engine. User preferences may be indicated explicitly via a user interface control that permits selection of preferred sets of content from a plurality of content options. User preferences also may be indicated implicitly, for instance, based upon previous search behavior or the like. Upon receiving a user preference indication, the search engine requests presentation of the preferred content from the third-party provider each time the user requests presentation of the search engine homepage. In this way, the user is provided with a customized experience and is able to view desired information upon navigating to a search engine homepage.

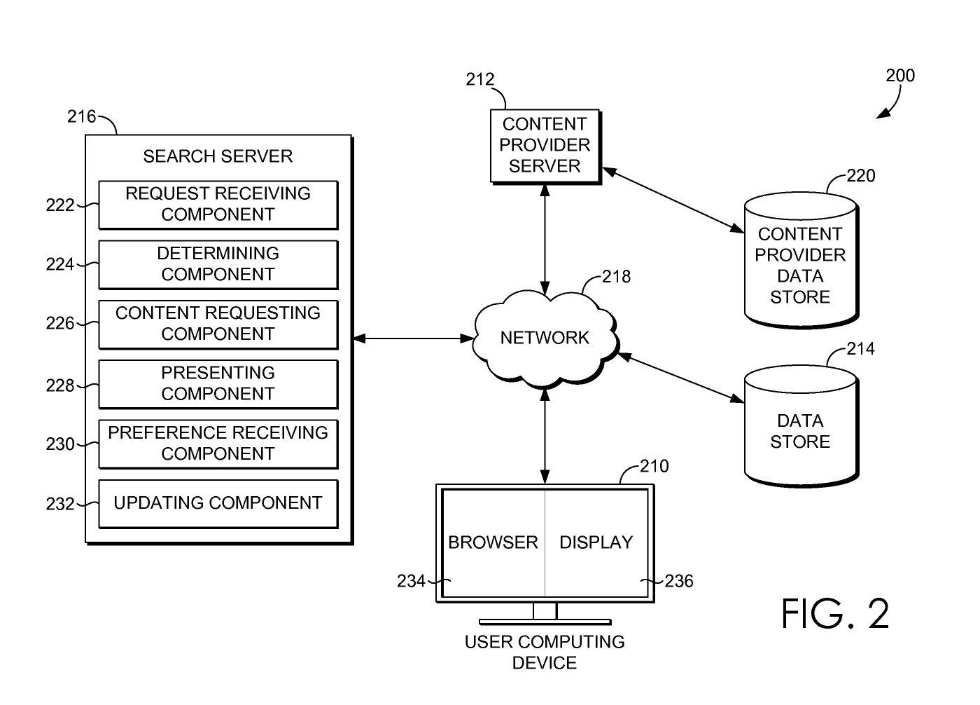

Referring now to FIG. 2, a block diagram is provided illustrating an exemplary computing system 200 in which embodiments of the present invention may be employed. Generally, the computing system 200 illustrates an environment in which third-party provided content may be integrated with search engine homepages. Among other components not shown, the computing system 200 generally includes a user computing device 210, a content provider server 212, a data store 214, and a search server 216, all in communication with one another via a network 218. The network 218 may include, without limitation, one or more local area networks (LANs) and/or wide area networks (WANs). Such networking environments are commonplace in offices, enterprise-wide computer networks, intranets and the Internet. Accordingly, the network 218 is not further described herein.

It should be understood that any number of user computing devices and search engines may be employed in the computing system 200 within the scope of embodiments of the present invention. Each may comprise a single device/interface or multiple devices/interfaces cooperating in a distributed environment. For instance, the search server 216 may comprise multiple devices and/or modules arranged in a distributed environment that collectively provide the functionality of the search server 216 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the user computing device 210, as an Internet-based service, or as a module inside the content provider server 212 and/or the search server 216. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search engines or user computing devices. By way of example only, one or both of the content provider server 212 and/or the search server 216 might be provided as a single server (as shown), a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 210 may include any type of computing device, such as the computing device 100 described with reference to FIG. 1, for example. Generally, the client computing device 210 includes a browser 234 and a display 236. The browser 234, among other things, is configured to render search engine home pages (or other online landing pages), in association with the display 236 of the client computing device 210. The browser 234 is further configured to receive user input of requests for various web pages (including search engine home pages), receive user input search queries (generally input via a user interface presented on the display 236 and permitting alpha-numeric and/or textual input into a designated search box) and to receive content for presentation on the display 236, for instance, from the search server 216 and/or the content provider server 212. It should be noted that the functionality described herein as being performed by the browser 234 may be performed by any other application capable of rendering Web content. Any and all such variations, and any combination thereof, are contemplated to be within the scope of embodiments of the present invention.

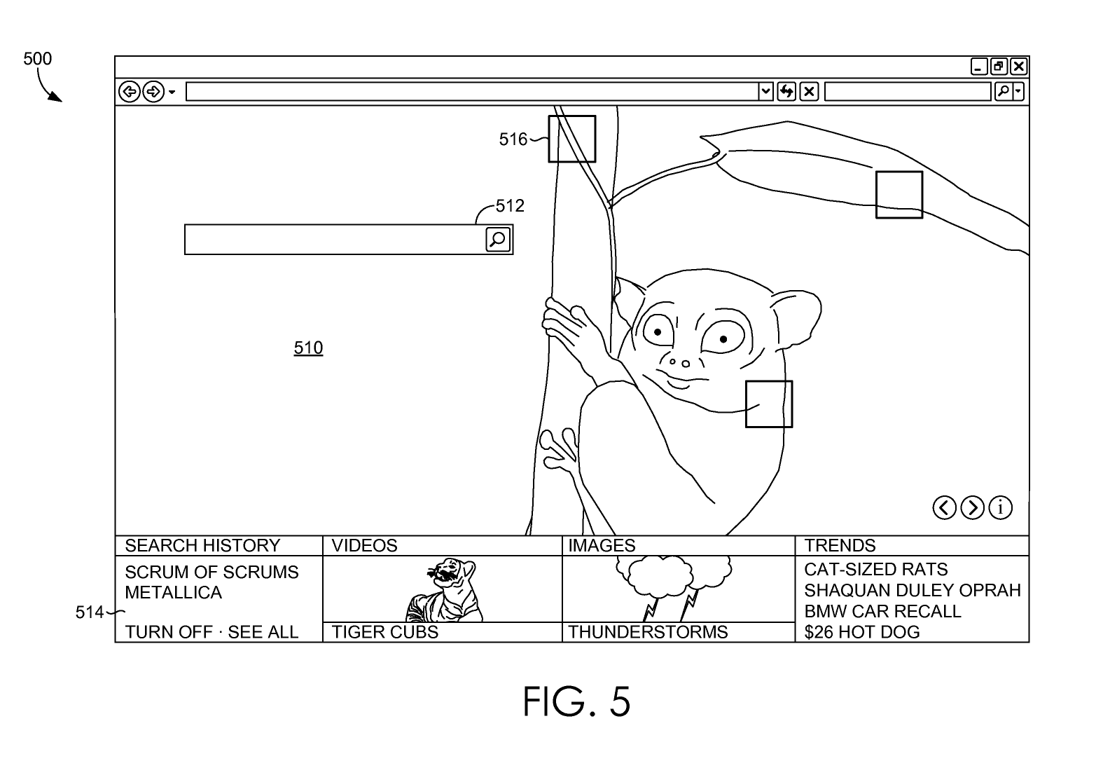

As previously set forth, embodiments of the present invention provide systems and methods for integrating third-party provided content with search engine homepages. Search engine homepages or other landing pages from which a search may be conducted oftentimes include content in addition to a designated search box configured to permit alpha-numeric and/or textual input related to a desired query. Such content may include, by way of example only, an image (e.g., a background image having the designated search box overlaid thereupon), a color (for instance, a background color having an image and/or a designated search box overlaid thereupon), or a hotspot, that is, a specified region within the search engine homepage that, upon user interaction therewith, additional information or functionality is provided. The content may additionally include one or more page tiles or regions containing specific information, as more fully described below with reference to the screen display 500 of FIG. 5. One exemplary search engine homepage that includes some or all of such content is the BING search engine homepage provided by Microsoft Corporation of Redmond, Wash.

Typically, the content presented in association with a search engine homepage is provided by the accompanying search engine. For instance, content presented in association with the BING search engine homepage is generally provided by a BING search server. However, there are third-party content providers that are capable of providing a richer and more dynamic content experience centered on particular topics than a search engine. For instance, ESPN® is likely capable of providing richer and more dynamic content with respect to sports than the BING search engine is. Thus, embodiments of the present invention enable and facilitate such third party content providers providing this rich, dynamic content in association with the search engine homepage.

Accordingly, the content provider server 212 is a computing device associated with a third-party content provider, that is, a content provider that is independent of the search engine. Generally, the third-party content provider is capable of providing rich and dynamic content related to one or more particular topics or tasks, for instance, sports, stocks, finance, and the like. The content provider server 212 has access to a content provider data store 220 wherein such rich, dynamic, topic/task-related content is stored. Thus, the illustrated content provider data store 220 is configured to store information, e.g., rich and dynamic information, pertaining to one or more particular topics or tasks. In embodiments, the content provider data store 220 is configured to be searchable for one or more of the items stored in association therewith. It will be understood and appreciated by those of ordinary skill in the art that the information stored in association with the content provider data store 220 may be configurable and may include any information relevant to a particular topic or task. The content and volume of such information are not intended to limit the scope of embodiments of the present invention in any way. Further, though illustrated as a single, independent component, the content provider data store 220 may, in fact, be a plurality of storage devices, for instance, a database cluster, portions of which may reside in association with the content provider server 212, the user computing device 210, another external computing device (not shown), and/or any combination thereof.

With continued reference to FIG. 2, the search server 216 is configured to receive and respond to requests that it receives from components associated with user computing devices, for instance, the browser 234 associated with the client computing device 210. Those skilled in the art of the present invention will recognize that embodiments of the present invention may be implemented with any number of searching utilities. For example, an Internet search engine or a database search engine may utilize the present invention. These search engines are well known in the art, and commercially available engines share many similar processes not further described herein.

As illustrated, the search server 216 includes a request receiving component 222, a determining component 224, a content requesting component 226, a presenting component 228, a preference receiving component 230, and an updating component 232. The illustrated search server 216 also has access to a data store 214. The data store 214 is configured to store information pertaining to search engine homepage content. In various embodiments, such information may include, without limitation, images (e.g., images to be displayed as search engine homepage background images), hotspots, page tiles and associated content, and user-indicated search engine homepage content preferences. In embodiments, the data store 214 is configured to be searchable for one or more of the items stored in association therewith. It will be understood and appreciated by those of ordinary skill in the art that the information stored in association with the data store 214 may be configurable and may include any information relevant to search engine homepages and/or user-indicated content preferences for search engine homepages. The content and volume of such information are not intended to limit the scope of embodiments of the present invention in any way. Further, though illustrated as a single, independent component, the data store 214 may, in fact, be a plurality of storage devices, for instance a database cluster, portions of which may reside in association with the search server 216, the user computing device 210, another external computing device (not shown), and/or any combination thereof.

The request receiving component 222 of the search server 216 is configured to receive requests for presentation of search engine homepages. Typically, such a request is received via a browser associated with a user computing device, for instance, the browser 234 associated with the user computing device 210.

The determining component 224 of the search server 216 is configured to determine whether or not a user associated with a requesting user computing device has an explicitly or implicitly indicated preference for content to be presented in association with the requested search engine homepage. Such an indicated preference may be for one or more sets of third-party provided content. In embodiments, such preference may also include a preference for one or more particular search engine homepage elements in association with which the preferred content is to be presented. Exemplary search engine homepage elements may include, without limitation, images (e.g., images to be displayed as search engine homepage background images), hotspots, page tiles, page colors, and the like. Thus, by way of example, a user may specify a preference for presentation of content provided by ESPN® in association with one or more page tiles (more fully described below with reference to FIG. 5) while having the background image provided by a news provider, e.g., MSNBC®. Additionally, as previously set forth, page tiles are regions of the search engine homepage containing specific information. For instance, one page tile may present weather information, another tile may present stock information, and yet another tile may present sports information. Further, if a preference is set for multiple page tiles for presentation of the same set of third-party provided content, the content from the set that is presented may still vary. For instance, if the preference for two page tiles is sports and sports content is provided by ESPN®, one tile may present college sports news and/or scores and the other tile may present professional sports news and/or scores. Or, each tile may represent a different sport. Any and all such variations, and any combination thereof, are contemplated to be within the scope of embodiments of the present invention and each of these levels of customization may be set by the user. It should be noted that content selection preferences may be set based on content categories (e.g., sports, news, weather, etc.) and/or set by content providers (e.g., ESPN®, MSNBC, WEATHER.COM, etc.) as desired.

In addition to setting content preferences and accessing a search engine homepage having preferred content directly through the homepage URL, once a user is aware that content on a search engine homepage may be provided by particular third-party content provider, there may be other user-initiated entry points into the experience. For instance, entry into the BING search engine homepage having content associated therewith that is provided by ESPN® may be provided by the user inputting the URL bing.com/ESPN rather than merely “bing.com.” Or there may be an ESPN-branded BING entry point, e.g., ESPN.bing.com. Any and all such variations and any combination thereof are contemplated to be within the scope of embodiments of the present invention.

Upon the determining component 224 determining that the user has an explicitly or implicitly indicated third-party provided content preference, the content requesting component 226 of the search server 216 is configured to request, from the third-party content provider, presentation of at least a portion of the preferred content set in association with the search engine homepage. As more fully described below with reference to the preference receiving component 228, the content requesting component 226 is further configured to request, from a third-party content provider, presentation of at least a portion of a newly-indicated preferred content set, that is, contemporaneously with the user indicating a content preference (e.g., via a user interface control). Upon receiving a request from the content requesting component 226, the content provider server 212 is configured to retrieve the requested content (e.g., from the content provider data store 220) and transmit (e.g., via the network 218) the requested content to the user computing device 210 for presentation in association with the display 236.

It should be noted that once a preference is indicated by a user for particular third-party provided content to be presented in association with one or more elements of a search engine homepage, the content provider server may automatically provide such content upon the user requesting presentation of the search engine homepage. In such embodiments, the content requesting component 226 does not need to request the content from the third-party content provider server.

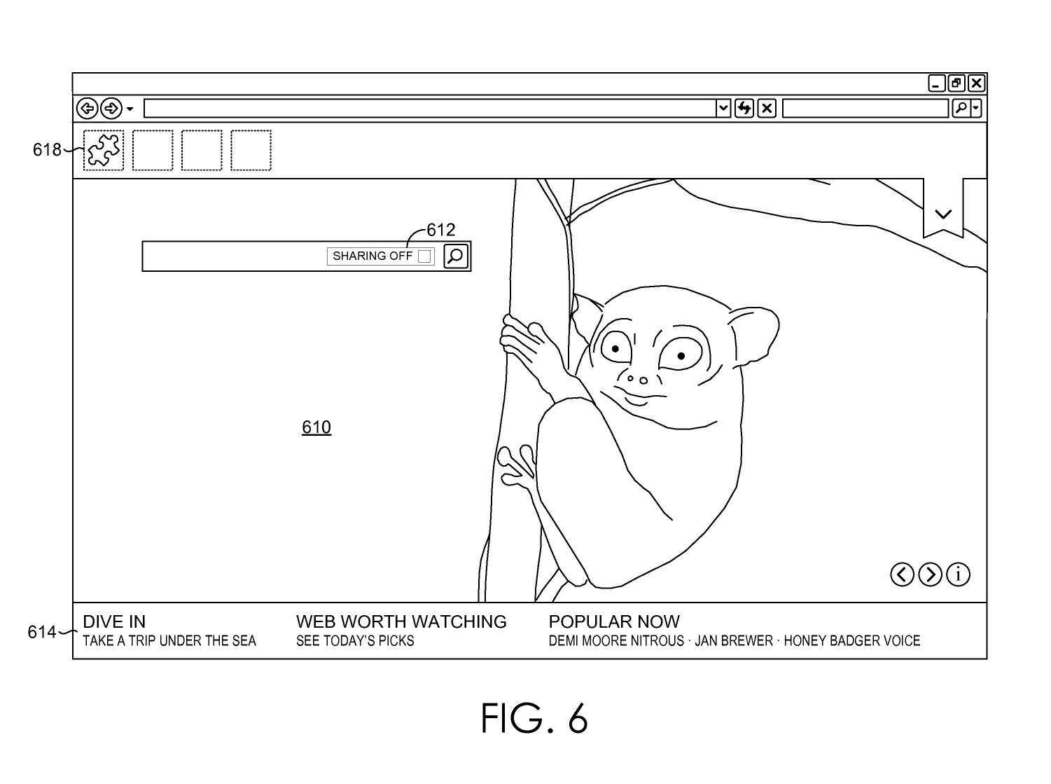

The presenting component 228 of the search server 216 is configured to transmit (e.g., via the network 218) a requested search engine homepage for presentation in association with the display 236 of the user computing device 210. To the extent it is determined (for instance, by the determining component 224) that one or more elements of the search engine homepage does not have a third-party provided content preference associated therewith, the presenting component 228 of the search server 216 is configured to transmit content for presentation in association with such element. The presenting component 228 is further configured to transmit for presentation a designated search box configured to permit alpha-numeric and/or textual input to be entered for requesting a search to be performed. Exemplary search boxes are shown in association with FIGS. 5 and 6, more fully described below.

The presenting component 228 is additionally configured to transmit for presentation in association with the display 236 of the user computing device 210 a user interface control that permits selection of preferred content for presentation in association with one or more elements of a search engine homepage, such selection being from a plurality of third-party provided content options. It will be understood and appreciated by those of ordinary skill in the art that such a control may take various forms and that the form or manner in which the user interface control is presented is not intended to limit the scope of embodiments of the present invention. An exemplary puzzle-like control is shown and more fully-described below with reference to FIG. 6.

The preference receiving component 230 of the search server 216 is configured to receive, via a user interface control, a user selection of a preferred set of third-party provided content. The preference receiving component 230 may further be configured to receive, via a user interface control, a user selection of one or more particular search engine homepage elements with which a preferred content selection is to be associated. A received user preference may be received to replace or change an existing preference and/or may be received to set a preference to one or more search engine homepage elements not previously having a content preference associated therewith. Any and all such variations, and any combination thereof, are contemplated to be within the scope of embodiments of the present invention.

In embodiments, a search engine may want to make sure that content provided by third-party content providers and presented in association with a search engine homepage is current and up-to-date. Accordingly, the updating component 232 of the search server 216 is configured to query the content provider server 212 to determine whether content provided by the content provider server 212 for presentation in association with a search engine homepage is current or fresh. In this way, the search engine maintains a quality control check over content provided by third parties and presented in association with the search engine homepage.

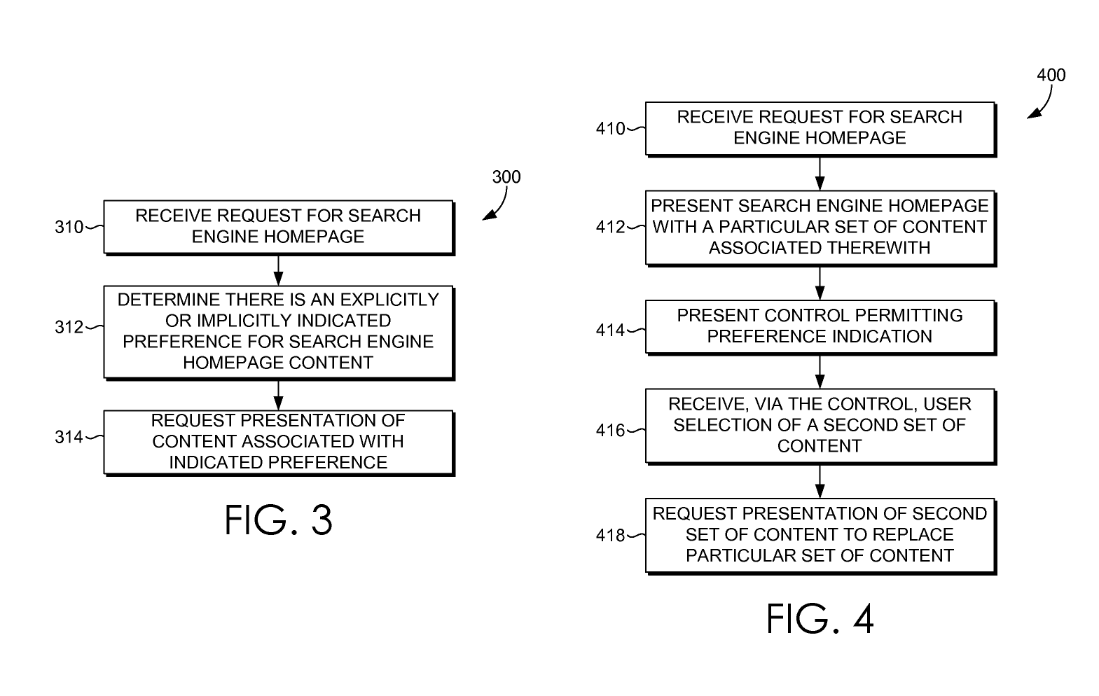

Turning now to FIG. 3, a flow diagram is illustrated showing an exemplary method 300 for integrating third party content with search engine homepages, in accordance with an embodiment of the present invention. As indicated at block 310, a request for presentation of a search engine homepage is received from a user, for instance, received from a user associated with the user computing device 210 of FIG. 2 by the request receiving component 222 of the search server 216 via the network 218. As indicated at block 312, it is then determined whether or not the user has an indicated preference for a particular set of content provided by a third party for presentation in association with one or more elements of the search engine homepage (e.g., utilizing the determining component 224 of the search server 216 of FIG. 2). The user may have indicated a content preference, by way of example only, via a user interface control associated with the search engine homepage during a previous search session. Upon determining that the user has an indicated preference, presentation is requested, from the third party, for presentation of at least a portion of the particular set of content in association with the search engine homepage, e.g., utilizing content requesting component 226 of the search server of FIG. 2. This is indicated at block 314.

With reference to FIG. 4, shown is flow diagram illustrating another exemplary method 400 for integrating third party content with search engine homepages, in accordance with an embodiment of the present invention. As indicated at block 410, a request for presentation of a search engine homepage is received (e.g., by the request receiving component 222 of the search server 216 of FIG. 2 via the network 218) from a user, for instance, a user associated with the user computing device 210. As indicated at block 412, the search engine homepage is presented (e.g., by presenting component 228 of the search server 216 of FIG. 2), the search engine homepage having a particular set of content associated therewith. In embodiments, the particular set of content includes content provided by the search engine associated with the requested search engine homepage. In other embodiments, the particular set of content includes content provided by a third party and indicated to be preferred during a previous search session of the user. Any and all such variations, and any combination thereof, are contemplated to be within the scope of embodiments of the present invention.

As indicated at block 414, also presented is a user interface control, selection of which permits the user to indicate a preference for one or more sets of content other than the particular set of content presented in association with the search engine homepage at block 412. One exemplary user interface control is shown and more fully described below with reference to FIG. 6. User selection of a second set of content from the one or more other sets of content via the user interface control is then received (e.g., utilizing preference receiving component 230 of the search server 216 of FIG. 2), as indicated at block 416. Presentation of at least a portion of the second set of content is then requested from a third party content provider (e.g., utilizing the content requesting component 226 of the search server 216 of FIG. 2) such that the requested content replaces some or all of the particular set of content presented in association with the search engine homepage. This is indicated at block 418.

Turning now to FIG. 5, an exemplary screen display 500 is illustrated showing a search engine homepage integrated with third-party provided content, in accordance with an embodiment of the present invention. The exemplary screen display 500 includes a background image 510, a designated search box 512 configured to receive alpha-numeric and/or textual input, a plurality of page tiles 514 and a plurality of hotspots 516. In the illustrated screen display 500, the background image 510, the page tiles 514 and the hotspots 516 all represent search engine homepage elements for which content preferences may be indicated.

Turning now to FIG. 6, another exemplary screen display 600 is illustrated, this one showing a search engine homepage integrated with third-party provided content and having an exemplary content-preference-indication control, in accordance with an embodiment of the present invention. The exemplary screen display 600 includes a background image 610, a designated search box 612 configured to receive alpha-numeric and/or textual input, one or more page tiles 614, and a content-preference-indication control 618. In the illustrated embodiment, user selection of the image of the puzzle piece associated with the content-preference-indication control 618 may initiate presentation of a menu or other selection interface (not shown) from which the user may select preferred content. As the user sets preferences, an indication of such preferences and/or past preferences may be shown in the other squares adjacent to the puzzle piece, that are shown without images in the screen display 600. In this way, a user may toggle between various third-party content quite easily.

As can be understood, embodiments of the present invention provide systems and methods for integrating third party content with search engine home pages providing users with a customized search experience upon navigating to a search engine home page. The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 300 of FIGS. 3 and 400 of FIG. 4 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for integrating third party content with search engine homepages, the method comprising:
receiving a request for presentation of a search engine homepage from a user;
determining that the user has an indicated preference for a particular set of content provided by a third party for presentation in association with the search engine homepage; and
upon determining that the user has an indicated preference, requesting, from the third party, presentation of at least a portion of the particular set of content in association with the search engine homepage.

2. The one or more computer-readable storage media of claim 1, wherein the search engine homepage has a plurality of elements associated therewith, and wherein requesting presentation of the at least a portion of the particular set of content in association with the search engine homepage comprises requesting presentation of the at least a portion of the particular set of content in association with at least one of the plurality of elements.

3. The one or more computer-readable storage media of claim 2, wherein the at least one of the plurality of elements is specified by a user.

4. The one or more computer-readable storage media of claim 2, wherein the plurality of elements includes one or more of a page tile, an image, a page color and a hotspot.

5. The one or more computer-readable storage media of claim 1, wherein the method further comprises presenting a control that permits the user to indicate a preference for one or more sets of content.

6. The one or more computer-readable storage media of claim 5, wherein the method further comprises:
receiving, via the control, a user selection of a second set of content, the second set of content being provided by a second third party; and
requesting, from the second third party, presentation of at least a portion of the second set of content in association with the search engine homepage.

7. The one or more computer-readable storage media of claim 6, wherein requesting, from the second third party, presentation of at least a portion the second set of content in association with the search engine homepage comprises requesting, from the second third party, presentation of the at least a portion of the second set of content such that it replaces some or all of the particular set of content presented in association with the search engine homepage.

8. The one or more computer-readable storage media of claim 6, wherein the search engine homepage has a plurality of elements associated therewith, and wherein requesting, from the second third party, presentation of the at least a portion of the second set of content in association with the search engine homepage comprises requesting, from the second third party, presentation of the at least a portion of the second set of content in association with at least one of the plurality of elements.

9. A system for integrating third party content with search engine homepages, the system comprising:
a computing device associated with a server having one or more processors and one or more computer-readable storage media; and
a data store coupled with the server,
wherein the server:
receives a request for presentation of a search engine homepage from a user;
determines that the user has an indicated preference for a particular set of content provided by a third party for presentation in association with the search engine homepage; and
upon determining that the user has an indicated preference, requests, from the third party, presentation of at least a portion of the particular set of content in association with the search engine homepage.

10. The system of claim 9, wherein the search engine homepage has a plurality of elements associated therewith, and wherein the server requests, from the third party, presentation of the at least a portion of the particular set of content in association with at least one of the plurality of elements.

11. The system of claim 10, wherein the at least one of the plurality of elements is specified by a user.

12. The system of claim 10, wherein the plurality of elements includes one or more of a page tile, an image, a page color and a hotspot.

13. The system of claim 9, wherein the server further presents a control that permits the user to indicate a preference for one or more sets of content.

14. The system of claim 13, wherein the server further:
receives, via the control, a user selection of a second set of content, the second set of content being provided by a second third party; and
requests, from the second third party, presentation of at least a portion of the second set of content in association with the search engine homepage.

15. The system of claim 14, wherein the server requests, from the second third party, presentation of the at least a portion of the second set of content such that it replaces some or all of the particular set of content presented in association with the search engine homepage.

16. A method being performed by one or more computing devices including at least one processor, for integrating third party content with search engine homepages, the method comprising:
receiving a request for a search engine homepage from a user;
presenting the search engine homepage having a particular set of content associated therewith;
presenting a control that permits the user to indicate a preference for one or more other sets of content;
receiving, via the control, a user selection of a second set of content selected from the one or more other sets of content; and
requesting presentation of at least a portion of the second set of content such that it replaces some or all of the particular set of content presented in association with the search engine homepage.

17. The method of claim 16, wherein each of the one or more other sets of content is provided by one or more third party content providers.

18. The method of claim 16, wherein the search engine homepage has a plurality of elements associated therewith, and wherein requesting presentation of at least a portion of the second set of content comprises requesting presentation of the at least a portion of the particular set of content in association with at least one of the plurality of elements.

19. The method of claim 18, wherein the at least one of the plurality of search engine homepage elements is specified by the user.

20. The method of claim 18, wherein the plurality of elements includes one or more of a page tile, an image, a page color and a hotspot.
